(19) United States
(12) Patent Application Publication
(10) Pub. No.: US 2026/0020719 A1
(43) Pub. Date: Jan. 22, 2026

(54) FRYER

(71) Applicant: COOL FRYER CO., LTD., Yokohama-shi (JP)

(72) Inventors: Hiroshi Fukuda, Yokohama-shi (JP); Sumito Yamada, Yokohama-shi (JP); Koji Yamada, Yokohama-shi (JP)

(73) Assignee: COOL FRYER CO., LTD., Yokohama-shi (JP)

(21) Appl. No.: 18/908,259

(22) Filed: Oct. 7, 2024

(30) Foreign Application Priority Data
Jul. 18, 2024 (JP) 2024-114676

(51) Int. Cl. A47J 37/12

(52) U.S. Cl. CPC A47J 37/1285; A47J 37/1257

(57) ABSTRACT

Provided is a fryer that can remove fried scraps accumulated in an oil tank without interrupting frying, the fryer including: a heater for heating a frying oil in the oil tank; an upper oil tank in which the heater is arranged and a food material is to be fried; a lower oil tank, which is provided below the upper oil tank so as to be continuous with the upper oil tank, includes a discharge port formed in a deepest portion to discharge fried scraps generated in the oil tank, together with the frying oil, and includes a plurality of inclined bottom plates inclined toward the discharge port; and a fried scrap discharge button configured to be operated so as to instruct a control unit to discharge, during frying, the fried scraps having sunk in the lower oil tank. When the fried scrap discharge button is operated, while frying in the upper oil tank is continued, a predetermined amount of the frying oil is added to the lower oil tank, and the discharge valve is opened to discharge, from the lower oil tank, substantially the same amount of the frying oil as that of the discharged frying oil.

### BACKGROUND OF THE INVENTION

### 1. Field of the Invention

The present invention relates to a fryer to be used for cooking fried food, and more particularly, to a fryer including a heater provided in a middle of an oil tank in a depth direction of the oil tank and configured to heat a frying oil.

### 2. Description of the Related Art

Hitherto, as the fryer of this type, there is known a fryer including an oil tank configured to store a frying oil therein, and a heater arranged in a middle of the oil tank in a depth direction of the oil tank. An upper oil tank above the heater is provided as a high-temperature section, and fried food is cooked in the upper oil tank. Meanwhile, a lower oil tank below the heater is provided as a low-temperature section, and moisture and fried scraps formed in the oil during cooking of fried food are sunken into the lower oil tank.

As a specific method of keeping the lower oil tank at a low temperature, there are known a method of air-cooling the lower oil tank by natural heat radiation without providing an active cooling unit (JP 2016-073487 A) and a method of forcibly cooling the lower oil tank by providing a water tank that covers the entire lower oil tank from the outside (JP 5901624 B2). When an oil temperature in the lower oil tank is suppressed to about 80 degrees Celsius by those methods, vaporization of moisture having sunk in the lower oil tank is prevented, and deterioration of the frying oil due to oxidation and oil spatter in the upper oil tank are suppressed. In addition, sinking of fried scraps in the lower oil tank can be facilitated.

Further, in a case of using a professional-use fryer to be used in stores and the like, it is required to periodically change a large amount of frying oil stored in the oil tank, remove fried scraps having deposited in the oil tank, and clean the oil tank. For this reason, a discharge port leading to an external tank is formed in a deepest portion of the lower oil tank, and is configured to allow the frying oil in the oil tank to be discharged toward the external tank together with the fried scraps. In addition, a bottom plate of the lower oil tank is formed as an inclined bottom plate inclined toward the discharge port, and hence fried scraps that have sunk in the lower oil tank during frying deposit on the inclined bottom plate. When the frying oil is discharged to the external tank, the fried scraps flow into the discharge port together with the frying oil (JP 2016-073487 A and JP 5901624 B2).

For example, when a professional-use fryer is used to fry a large amount of food continuously for a long period of time, fried scraps of a large amount deposit on a bottom of the lower oil tank. When the cooking is continued as it is, a volume of the lower oil tank decreases, and hence there arise problems that the fried scraps easily float in the upper oil tank, and that deterioration of the frying oil easily progresses. Therefore, the fryer is convenient when being capable of removing the fried scraps from the oil tank even in the middle of continuous cooking.

However, in the related-art fryer, after frying is once finished and a temperature of the frying oil is lowered to a certain degree, the frying oil is discharged to the external tank, and the fried scraps are removed from the oil tank at that time. Further, the fryer of JP 2016-073487 A has a filtration circulation mode in which the frying oil is filtered while the frying oil is circulated between the oil tank and the external tank, but this filtration circulation mode is provided separately from a fryer mode in which frying is performed. Thus, the fried scraps in the oil tank have not been able to be removed unless frying is interrupted. That is, the related-art fryer cannot remove the fried scraps while frying is continued, which has been a problem for a professional-use fryer in which a large amount of food is fried.

### SUMMARY OF THE INVENTION

The present invention has been made in view of the problems described above, and has an object to provide a fryer capable of removing fried scraps accumulated in an oil tank while frying a large amount of food is continued without interruption, and capable of increasing operation efficiency.

That is, according to the present invention, there is provided a fryer, which is configured to heat a frying oil stored in an oil tank by a heater so as to fry a food material put into the oil tank, the fryer including: an upper oil tank in which the heater is arranged and the food material is to be fried; a lower oil tank, which is provided below the upper oil tank so as to be continuous with the upper oil tank, includes a discharge port formed in a deepest portion to discharge fried scraps generated in the oil tank, together with the frying oil, and includes a plurality of inclined bottom plates inclined toward the discharge port; a water-cooling jacket, which is provided around the lower oil tank and filled with cooling water, and is configured to forcibly cool the frying oil in the lower oil tank; a discharge valve configured to open and close a discharge flow path leading to the discharge port; a reserve tank, which is configured to remove the fried scraps from the frying oil discharged through the discharge valve, and to store the frying oil after removal of the fried scraps; a return flow path, in which an oil feed pump is provided, and through which the frying oil in the reserve tank is to be fed into the lower oil tank; a control unit configured to manage driving of the heater, opening and closing of the discharge valve, and driving of the oil feed pump; and a fried scrap discharge button configured to be operated so as to instruct the control unit to discharge, during frying, the fried scraps having sunk in the lower oil tank. Further, along with operation of the fried scrap discharge button, the control unit is configured to drive the oil feed pump to add a predetermined amount of the frying oil from the reserve tank to the oil tank, and to open the discharge valve to discharge the same amount of the frying oil as the predetermined amount of the frying oil from the lower oil tank.

According to the present invention, when the fried scrap discharge button is operated during frying in the upper oil tank, the predetermined amount t of the frying oil is discharged from the lower oil tank together with the fried scraps, and a new frying oil of substantially the same amount as the discharged amount is fed from the reserve tank into the lower oil tank. At this time, the new frying oil to be fed from the reserve tank is fed into not the upper oil tank but the lower oil tank, and hence the oil temperature in the upper oil tank during frying does not decrease rapidly. Accordingly, the fryer can remove the fried scraps accumulated in the oil tank while frying a large amount of food is continued without interruption, and can increase operation efficiency of the fryer.

### BRIEF DESCRIPTION OF THE DRAWINGS

FIG. 1 is a schematic sectional view for illustrating an example of an embodiment of a fryer to which the present invention is applied.

FIG. 2 is a block diagram for illustrating a control system of the fryer according to the embodiment.

FIG. 3 is a schematic sectional view for illustrating a state in which a frying oil flows near inclined bottom plates in the fryer according to the embodiment.

FIG. 4 is a plan view for illustrating a bottom of an oil tank.

### DESCRIPTION OF THE EMBODIMENTS

Now, a fryer according to the present invention is described in detail with reference to the attached drawings.

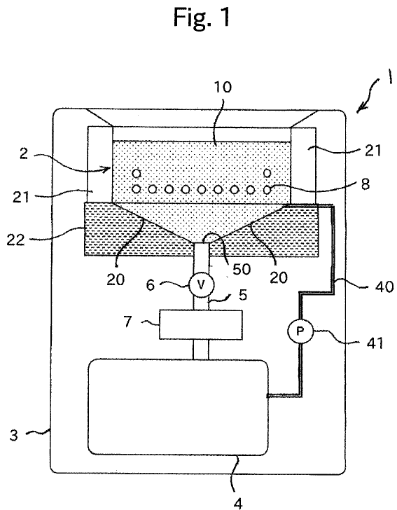

FIG. 1 is a view for illustrating an example of a professional-use fryer to which the present invention is applied. A fryer 1 is a freestanding type fryer to be used in, for example, kitchens of restaurant stores, and can perform frying under a state in which about 18 liters of a frying oil 10 is put into an oil tank.

The fryer 1 includes an oil tank 2 that stores a frying oil, a housing 3 that supports the oil tank 2, a reserve tank 4 housed in the housing 3 below the oil tank 2, and a discharge flow path 5 through which the frying oil is to be discharged from the oil tank 2 to the reserve tank 4. A discharge valve 6 is provided in the discharge flow path 5, and is configured to cause the frying oil in the oil tank 2 to flow by its own weight into the reserve tank 4 when the discharge valve 6 is opened. Further, a mesh filter 7 is provided in a middle of the discharge flow path 5. When the frying oil flowing toward the reserve tank 4 passes through the filter 7, large fried scraps are collected by the filter 7.

The oil tank 2 includes an upper oil tank 2a in which frying is performed, and a lower oil tank 2b, which is provided below the upper oil tank 2a so as to be continuous with the upper oil tank 2a. A heater 8 that heats the frying oil is provided in the upper oil tank 2a, and the frying oil in the upper oil tank 2a can be heated to any appropriate temperature by energizing the heater 8. Meanwhile, a discharge port connected to the discharge flow path 5 is formed in a deepest portion of the lower oil tank 2b. A plurality of inclined bottom plates 20 are arranged around the discharge port so as to be inclined toward the discharge port, and those inclined bottom plates 20 are joined together to form a bottom plate of the oil tank 2. In the illustrated example, four inclined bottom plates 20 are arranged around the discharge port so that the bottom plate of the oil tank 2 has a shape of an inverted quadrangular pyramid.

Further, a periphery of the upper oil tank 2a is covered with a heat insulating material 21, whereas a water-cooling jacket 22 filled with cooling water is provided around the lower oil tank 2b. Thus, when the heater 8 is energized, the frying oil 10 in the upper oil tank 2a, which is provided with the heater 8 and covered with the heat insulating material 21, is heated to a high temperature (for example, 180° C.). Meanwhile, the frying oil 10 in the lower oil tank 2b is forcibly cooled by the water-cooling jacket 22, and the frying oil 10 in the lower oil tank 2b is kept at a low temperature of less than 100° C. (for example, 80° C.). Although not shown, a supply pipe and a discharge pipe for cooling water are connected to the water-cooling jacket 22. The cooling water that has been increased in temperature due to cooling of the lower oil tank 2b can be discharged to the outside through the discharge pipe, and new low-temperature cooling water can be supplied through the supply pipe.

A food material is fried in the upper oil tank 2a in which the frying oil is heated by the heater 8. Meanwhile, moisture and fried scraps released from the food material into the frying oil during frying sink from the upper oil tank 2a into the lower oil tank 2b. As described above, the frying oil in the lower oil tank 2b is kept at a low temperature of less than 100° C., and hence the moisture that has reached an inside of the lower oil tank 2b sinks to the vicinity of the inclined bottom plates 20 without vaporizing. Further, the temperature of the frying oil 10 in the lower oil tank 2b is significantly lower than that in the upper oil tank 2a, and hence there is no convection of the frying oil from the lower oil tank 2b to the upper oil tank 2a, with the result that the fried scraps that have sunk in the lower oil tank 2b do not rise into the upper oil tank 2a but deposit on the plurality of inclined bottom plates 20.

Although the frying oil 10 flowing down from the oil tank 2 to the reserve tank 4 via the discharge flow path 5 passes through the filter 7, fine fried scraps and the moisture are contained in the frying oil 10 without being collected by the filter 7. That is, the filter 7 collects only fried scraps with relatively large sizes. Thus, the frying oil 10 that has passed through the filter 7 contains the fine fried scraps and the moisture, and the fine fried scraps and the moisture sink on the bottom of the reserve tank 4 after the frying oil 10 is stored for several hours in the reserve tank 4. For example, in a case in which the frying oil 10 is discharged from the oil tank 2 to the reserve tank 4 at the end of a day's work, and the frying oil 10 is kept in the reserve tank 4 as it is until the next morning, the fine fried scraps and the moisture settle on the bottom of the reserve tank 4 when the work is started the next day.

Meanwhile, a return flow path 40 is provided between the reserve tank 4 and the oil tank 2, and the frying oil 10 present in the reserve tank 4 can be appropriately fed into the oil tank 2 by driving an oil feed pump 41. The return flow path 40 is not connected to the bottom of the reserve tank 4, and thus the fine fried scraps and the moisture that have settled on the bottom of the reserve tank 4 are not sucked up into the return flow path 40 but remain in the reserve tank 4 even when the oil feed pump 41 is driven. Further, the return flow path 40 is connected to the oil tank 2 below the heater 8, more specifically, connected above upper ends of the inclined bottom plates 20 of the lower oil tank 2b and at a boundary portion between the upper oil tank 2a and the lower oil tank 2b.

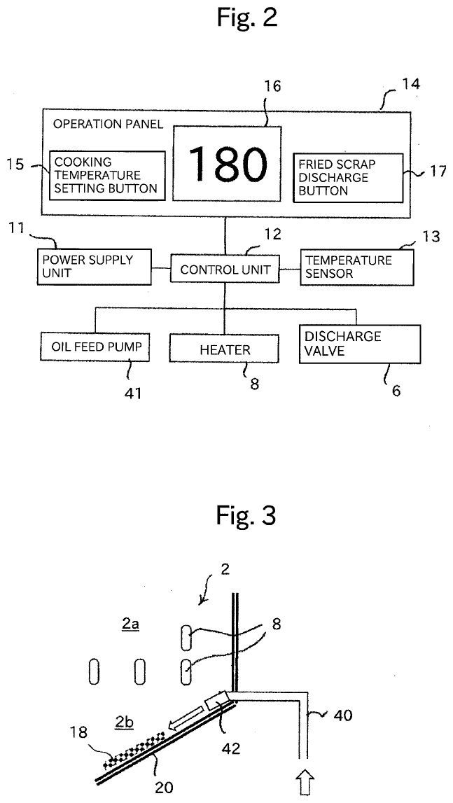

FIG. 2 is a block diagram for illustrating a control system of this fryer 1. This fryer 1 includes a power supply unit 11 to which power is supplied from an AC power source, and a control unit 12 with a built-in microprocessor receives power from the power supply unit 11 to control operations of the oil feed pump 41, the heater 8, and the discharge valve 6. Further, a temperature sensor 13 that measures the temperature of the frying oil 10 in the upper oil tank 2a is connected to the control unit 12. In order that the frying oil 10 in the upper oil tank 2a is kept at a predetermined temperature (for example, 180° C.), with reference to an output signal of the temperature sensor 13 at predetermined time intervals, the control unit 12 instructs the power supply unit 11 to supply power to the heater 8 in accordance with a program stored in advance. An operation panel 14 serving as a user interface is connected to the control unit 12, and the operation panel 14 includes a cooking temperature setting button 15 and a display unit 16 that shows a current temperature of the frying oil 10 in the upper oil tank 2a.

The operation panel 14 includes a fried scrap discharge button 17 for discharging the fried scraps having deposited in the lower oil tank 2b out of the oil tank 2 during cooking. When a user operates the button 17, the control unit 12 opens the discharge valve 6 for a predetermined time period, and the frying oil 10 in the lower oil tank 2b is discharged toward the reserve tank 4 by a predetermined amount (for example, about 4 liters). Further, in conjunction therewith, the control unit 12 activates the oil feed pump 41 to feed the frying oil 10 in the reserve tank 4 into the oil tank 2.

When the fried scrap discharge button 17 is operated by a user, the oil feed pump 41 feeds, into the oil tank 2, substantially the same amount of the frying oil 10 as the amount of the frying oil 10 discharged from the lower oil tank 2b. The control unit 12 controls an opening time period of the discharge valve 6 and an operation time period of the oil feed pump 41 to finally keep an oil surface height in the oil tank 2 at a substantially constant position.

With the frying oil discharge button 17 being operated as described above, a predetermined amount of the frying oil 10 is discharged from a discharge port 50 located at the deepest portion of the lower oil tank 2b, and the fried scraps, which deposit on the inclined bottom plates 20 located so as to surround the discharge port 50, flow into the discharge port 50 together with the frying oil. In this manner, the fried scraps can be discharged from the oil tank 2 even during frying. Further, the frying oil 10 to be discharged from the oil tank 2 by operating the frying oil discharge button 17 is a low-temperature (less than 100° C.) frying oil in the lower oil tank 2b, and hence a temperature of the fried scraps contained therein is also at the same low level. Accordingly, there is no trouble that the fried scraps collected by the filter 7 ignite.

The temperature of the frying oil 10 to be fed into the oil tank 2 from the reserve tank 4 is close to a room temperature. Thus, when the oil feed pump 41 feeds the frying oil 10 in the reserve tank 4 into the upper oil tank 2a along with the operation of the fried scrap discharge button 17, the temperature of the frying oil 10 in the upper oil tank 2a decreases, and frying is required to be interrupted until the temperature recovers. In this respect, in the fryer according to this embodiment, the return flow path 40 for feeding the frying oil in the reserve tank 4 into the oil tank 2 is connected to the boundary portion between the upper oil tank 2a and the lower oil tank 2b, and hence even when substantially the same amount of the frying oil as the amount of the frying oil 10 discharged from the lower oil tank 2b is fed into the oil tank 2 from the return flow path 40, replacement of the frying oil 10 in the upper oil tank 2a hardly occurs. Thus, it is possible to continue frying in the upper oil tank 2a while discharging the fried scraps from the lower oil tank 2b.

When the fried scrap discharge button 17 is operated, the discharging of the frying oil 10 from the lower oil tank 2b and the feeding of the oil from the reserve tank 4 into the oil tank 2 by the oil feed pump 41 are not required to be performed simultaneously. For example, the feeding of the oil from the reserve tank 4 into the oil tank 2 may be started after the opening of the discharge valve 6, or conversely, the opening of the discharge valve 6 may be performed after the feeding of the oil from the reserve tank 4 into the oil tank. In short, it is only required that the amount of the oil in the oil tank 2 after the control unit 12 completes a series of operations for discharging the fried scraps be substantially the same as that before the fried scraps are discharged.

Meanwhile, when the discharge valve 6 is opened prior to feeding of the oil from the reserve tank 4 into the oil tank 2, the amount of the frying oil in the oil tank 2 is reduced temporarily. Thus, there is reduced the amount of the frying oil in the upper oil tank 2a in which frying is performed, and hence there is a fear in that frying is hindered. For this reason, when the fried scrap discharge button 17 is operated, it is preferred to drive the oil feed pump 41 prior to opening of the discharge valve 6 so as to increase the amount of the oil in the upper oil tank 2a, and then open the discharge valve 6.

Further, from the viewpoint of facilitating discharging of the fried scraps having deposited on the inclined bottom plates 20 out of the oil tank 2, it is preferred to open the discharge valve 6 so as to discharge the frying oil from the lower oil tank 2b simultaneously with feeding of the frying oil in the reserve tank 4 into the lower oil tank 2b by the oil feed pump 41. When the frying oil is fed into the lower oil tank 2b by the oil feed pump 41, a flow of the frying oil in the lower oil tank 2b occurs, and as a result, the fried scraps on the inclined bottom plates 20 easily float up in the lower oil tank 2b. Thus, it becomes easier to discharge the fried scraps out of the oil tank 2 from the discharge port 50 together with the frying oil 10.

In addition, in order to facilitate discharging of the fried scraps, as illustrated in FIG. 3, it is preferred to provide a nozzle 42 at an end portion of the return flow path 40 on the oil tank 2 side. The nozzle 42 guides the frying oil fed from the reserve tank 4 into the oil tank 2 in a direction along the inclined bottom plates 20 of the lower oil tank 2b. In a case of using the nozzle 42, when the oil feed pump 41 is driven to feed the frying oil 10 into the oil tank 2 from the return flow path 40, the frying oil 10 ejected from the nozzle 42 flows along the inclined bottom plates 20, and fried scraps 18 having deposited on the inclined bottom plates 20 are dropped toward the discharge port in the deepest portion. This can facilitate discharging of the fried scraps 18. In addition, it is possible to prevent the low-temperature frying oil fed from the reserve tank 4 into the oil tank 2 from being stirred with the high-temperature frying oil in the upper oil tank 2a, which is also suitable for continuing frying in the upper oil tank 2a.

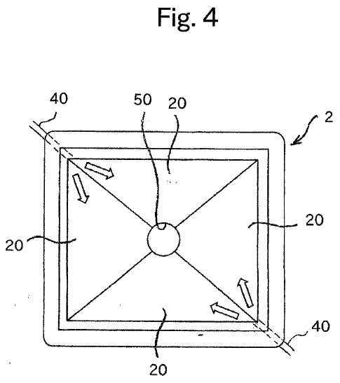

FIG. 4 is a plan view for illustrating the oil tank 2 when seen from above. The bottom of the oil tank 2 is formed of four inclined bottom plates 20 joined together, and the discharge port 50 is formed in the deepest portion at a center of the bottom. The return flow path 40 is connected to each of two corner portions of the oil tank 2 opposed to each other across the discharge port 50, and the nozzle 42 is provided at a position of each of the corner portions. The nozzle 42 feeds the frying oil in two directions in a branched manner, and is configured to eject the frying oil 10 to each of two adjacent inclined bottom plates 20 as indicated by the arrows in FIG. 4.

With the frying oil 10 being ejected from the return flow path 40 to all the inclined bottom plates 20 as described above, a flow of the frying oil 10 toward the discharge port 50 is generated on each of the inclined bottom plates 20, and hence the fried scraps having deposited on those inclined bottom plates 20 can be forced to flow into the discharge port 50. Therefore, it is possible to actively cause the fried scraps to flow into the discharge flow path 5 along with opening of the discharge valve 6.

As described above, according to the fryer to which the present invention is applied, even when fried scraps of a large amount are generated in the oil tank by continuously cooking a large amount of fried food and the fried scraps deposit on the inclined bottom plates of the lower oil tank, it is possible to remove the fried scraps from the oil tank while continuing frying in the upper oil tank. This can increase operation efficiently of the fryer in frying.

What is claimed is:

1. A fryer, which is configured to heat a frying oil stored in an oil tank by a heater so as to fry a food material put into the oil tank, the fryer comprising:
an upper oil tank in which the heater is arranged and the food material is to be fried;
a lower oil tank, which is provided below the upper oil tank so as to be continuous with the upper oil tank, includes a discharge port formed in a deepest portion to discharge fried scraps generated in the oil tank, together with the frying oil, and includes a plurality of inclined bottom plates inclined toward the discharge port;
a water-cooling jacket, which is provided around the lower oil tank and filled with cooling water, and is configured to forcibly cool the frying oil in the lower oil tank;
a discharge valve configured to open and close a discharge flow path leading to the discharge port;
a reserve tank, which is configured to remove the fried scraps from the frying oil discharged through the discharge valve, and to store the frying oil after removal of the fried scraps;
a return flow path, in which an oil feed pump is provided, and through which the frying oil in the reserve tank is to be fed into the lower oil tank;
a control unit configured to manage driving of the heater, opening and closing of the discharge valve, and driving of the oil feed pump; and
a fried scrap discharge button configured to be operated so as to instruct the control unit to discharge, during frying, the fried scraps having sunk in the lower oil tank,
wherein, along with operation of the fried scrap discharge button, the control unit is configured to drive the oil feed pump to add a predetermined amount of the frying oil from the reserve tank to the oil tank, and to open the discharge valve to discharge the same amount of the frying oil as the predetermined amount of the frying oil from the lower oil tank.

2. The fryer according to claim 1, wherein the return flow path is connected to the lower oil tank above the inclined bottom plates.

3. The fryer according to claim 2, wherein a nozzle is provided at a connection portion between the lower oil tank and the return flow path, and is configured to guide the recycled frying oil to the inclined bottom plates.

4. The fryer according to claim 3, wherein the nozzle comprises a plurality of nozzles provided so as to correspond to the inclined bottom plates, respectively.

5. The fryer according to claim 4, wherein the control unit is configured to open the discharge valve simultaneously with the driving of the oil feed pump.
